(19) United States
(12) Patent Application Publication
(10) Pub. No.: US 2004/0205083 A1
(43) Pub. Date: Oct. 14, 2004

(54) Encapsulating unbuffered file access for improved disk throughput

(75) Inventor: Carlton A. Andrews, Austin, TX (US)

Correspondence Address: Ronald L. Chichester, Banker Botts L.L.P., One Shell Plaza, 910 Louisiana Street, Houston, TX, 77002-4995, US

(73) Assignee: DELL PRODUCTS L.P.

(21) Appl. No.: 10/413,013

(22) Filed: Apr. 14, 2003

(51) Int. Cl. G06F 17/00

(52) U.S. Cl. 707/102

(57) ABSTRACT

A method and system for unbuffered file access to enhance hard disk drive throughput is provided. Special subclasses of common open, read, write, and close calls are provided that discern and utilize the sector size and sector boundaries of the hard disk in question, as well as the buffer size and other parameters to eliminate the need for much of the buffering at the system memory. Unlike prior art systems, where I/O processing requires CPU utilization for movement in RAM and four simultaneous access to RAM, the present invention requires no CPU utilization for movement in RAM and has only two simultaneous access to RAM, thereby increasing throughput to the hard disk significantly.

### TECHNICAL FIELD

The present invention relates to computer systems. More particularly, the present invention relates to improving hard disk throughput by utilizing unbuffered file access.

### BACKGROUND

System memory buffering of file reading and writing has become the standard for many years. The intent is to buffer the data in high-speed memory and access the disk at optimal times. System buffering works well for small files that may be quickly written to memory, thereby allowing the program to continue its flow while the operating system writes the file as resources become available. While reading files, the system anticipates that a continuous stream of data will be read and that the system will read additional data into its buffer and cache the data in that buffer.

A typical input/output scenario for computer system is illustrated in FIG. 1. A system 100 has a first hard disk drive 102 that operates at approximately 69 MB/sec. Information from drive 102 is transmitted to drive buffer 104, which itself has a higher transfer rate of, for example, 100 MB/sec. Information from the drive buffer 104 is then transmitted to, for example, a primary mechanism of the Intelligent Drive Electronics (“IDE”) Advanced Technology Attachment (“ATA”) (collectively “IDE/ATA”) system, such as IDE ATA 106 as illustrated in FIG. 1. Thereafter, the information is transmitted to, for example, the IDE controller 108 (either in the absence or presence of an ATA controller). The IDE controller 108 which also operates at a transfer rate of approximately 100 MB/sec. Information from the IDE controller is then transmitted to the PCI bus 110, which has a transfer rate of approximately 127 MB/sec. From the PCI bus 110, the information is transmitted to the system buffer memory 112 as illustrated in FIG. 1. The system buffer memory 112 is a portion of the main system 111, which contains the memory 114 and other system buffers such as system buffer memory 116. The information from the system buffer memory 112 is then transmitted to the memory 114 at the nominal rate of 532 MB/sec. Write statements to other devices would be pulled from memory 114 to the system buffer memory 116 as illustrated in FIG. 1. From there, the information would be transmitted to, for example, the PCI bus 118, with a nominal throughput rate of 127 MB/sec. Thereafter, the information is provided to, for example, the IDE controller 120 and/or the IDE ATA 122 and the drive buffer 124, which all nominally operate at a transfer rate of 100 MB/sec. Finally, from the drive buffer 124, the information is then provided to the second drive 126 at a nominal rate of 69 MB/sec.

Now that system architecture has become more advanced and disk drives, as well as their interfaces, often operate at half or a quarter of memory speeds, the additional time for moving the data around in memory can be more costly than beneficial in terms of performance. When creating or accessing large files, the benefit of all the memory buffering is non-existent except for those situations where relatively small amounts of data are accessed or manipulated at each input/output (“I/O”) operation.

Unfortunately, the tools and methods that programmers normally use to read, write and manipulate file data become very limited and unwieldy when working in a non-buffered environment. Data must be read or written in quantities of bytes that are multiples of the byte count of a full disk sector. One has to determine the sector size of a disk to do that. Positioning seeks into a file must also be on a sector boundary as must memory allocation. This makes extracting data at fixed byte positions awkward. Moreover, closing the written file will leave the count of valid data bytes (file size) at a multiple of the sector size.

If a programmer tries to use the standard CFile class (or any standard library functions) for unbuffered I/O, the programmer will find that the calls to Seek, Read and Write likely will throw exceptions when write quantities: are not sector multiples; or go to a location that is not on a sector boundary or when the memory is not aligned on a integer multiple of the sector size. Multimedia stream file I/O classes exist which optionally use unbuffered I/O for fast read and write of data streams like video and sound utilize similar disk access. These special libraries are not normally included in the standard programming environment and utilize methods that are uncommon and unnatural to the typical software developer. Many of these libraries require the pre-allocation of disk space. Often times that space must be contiguous. There is, therefor, a need in the art for a seek, read and write mechanism that will not throw exceptions in an unbuffered environment, and which does not require special programming or knowledge on the part of the programmer/developer.

### SUMMARY OF THE INVENTION

The method of the present invention enables unbuffered file access that enhances hard disk drive throughput. Special subclasses of common open, read, write, and close calls are utilized as part of standard coding techniques. The special subclasses discern and/or utilize the sector size and sector boundaries of the hard disk in question. Additional information, such as the buffer size and other parameters are used to eliminate the need for much of the buffering at the system memory. Unlike prior art systems, where I/O processing requires CPU utilization for movement in RAM and four simultaneous access to RAM, the present invention requires no CPU utilization for movement in RAM and has only two simultaneous access to RAM, thereby increasing throughput to the hard disk significantly.

The methods of the present invention can be embodied in hardware or software, or some combination of hardware and software. Ideally, the methods of the present invention are an encapsulation of file access method calls into a C++ class or a software type or structure. The encapsulated method calls are generally (although not required to be) similar to those used by developers so that the latter may take quick advantage performance of unbuffered I/O without worrying about the sector boundaries. For example, the call statements for the methods of the present invention can be written and made to be similar to or interchangeable with those functions and call statements used by programmers familiar with, for example, the Microsoft Foundation Classes (“MFC”) for file access. MFC is available from the Microsoft Corporation of Redmond, Wash.

Unbuffered I/O access easily can achieve up to a 30% speed increase when accessing disk drives on, for example, 32 bit and 64 bit systems. Such an increase can make data load process much faster. The subclass of the present invention may be used for sequential writes and (perhaps) random writes within the file. The constraint to the programmer is that all writes except the last write must be a multiple of 1 kilobyte.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a block diagram of a prior art computer system illustrating the flow of information from one hard disk to another using a buffered memory system.

FIG. 2 is a block diagram of a computer system utilizing unbuffered memory usage according to the teachings of the present invention.

FIG. 3 is a flowchart illustrating the open method according to the teachings of the present invention.

FIG. 4 is a flowchart illustrating the read method according to the teachings of the present invention.

FIG. 5 is a flowchart illustrating the write method according to the teachings of the present invention.

FIG. 6 is a flowchart illustrating the close method according to the teachings of the present invention.

FIG. 7 is a plot illustrating buffered and unbuffered throughput for read, write, and read/write statements.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives and equivalents falling within the spirit and scope of the invention, as defined by the appended claims, are to be covered.

### DETAILED DESCRIPTION OF THE INVENTION

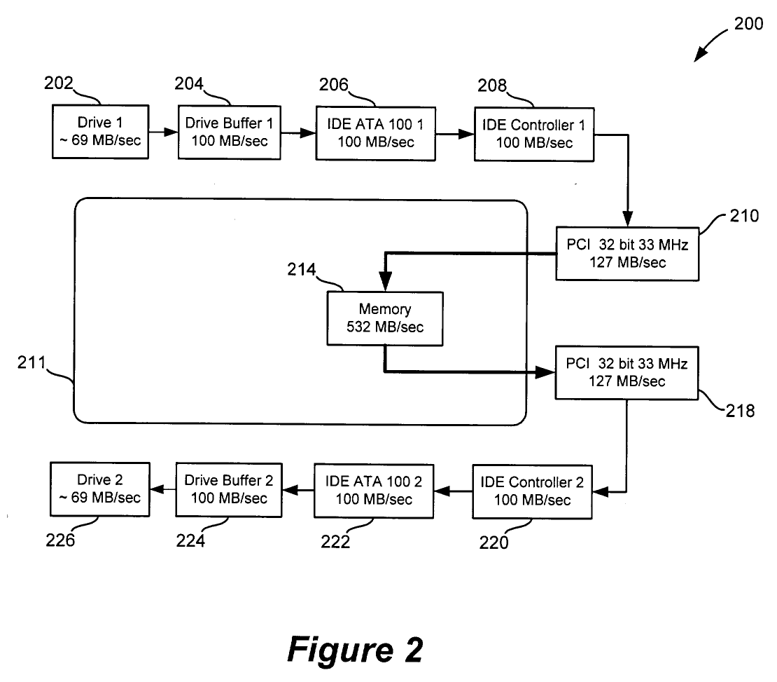

The input/output scenario for the computer system of the present invention is illustrated in FIG. 2. The system 200 has a first hard disk drive 202 that operates at approximately 69 MB/sec. Information from drive 202 is transmitted to drive buffer 204, which itself has a higher transfer rate of, for example, 100 MB/sec. Information from the drive buffer 204 is then transmitted to, for example, a primary mechanism of the Intelligent Drive Electronics (“IDE”) Advanced Technology Attachment (“ATA”) (collectively “IDE/ATA”) system, such as IDE ATA 106 as illustrated in FIG. 2. Thereafter, the information is transmitted to, for example, the IDE controller 208 (in the absence or the presence of an ATA controller), which also operates at a transfer rate of approximately 100 MB/sec. Information from the IDE controller is then transmitted to the PCI bus 210, which has a transfer rate of approximately 127 MB/sec. From the PCI bus 210, the information is transmitted to the system buffer memory 212 as illustrated in FIG. 2. The system buffer memory 212 is a portion of the main system 211, which contains the memory 214 and other system buffers such as system buffer memory 216. The information from the system buffer memory 212 is being transmitted to the memory 214 at the nominal rate of 532 MB/sec. Write statements to other devices are then pulled from the memory 214 to the system buffer memory 216 as illustrated in FIG. 2. From there, the information is transmitted to, for example, the PCI bus 218, with a nominal throughput rate of 127 MB/sec. Thereafter, information is provided to, for example, the IDE controller 220 and the IDE ATA 222 and the drive buffer 224, which all nominally operate at a transfer rate of 100 MB/sec. Finally, from the drive buffer 224, the information is then provided to the second drive 226 at a nominal rate of 69 MB/sec.

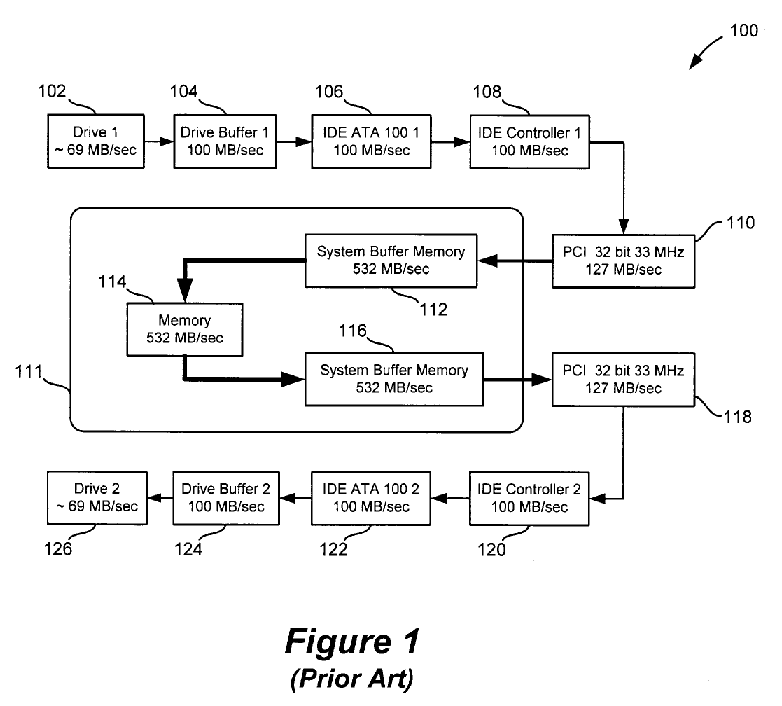

The system and method of the present invention enables unbuffered file access that enhances hard disk drive throughput. Special subclasses of common open, read, write, and close calls are utilized as part of standard coding techniques. The subclasses can be created from any computing language, although the use of object oriented languages, such as C++, enable the subclassing of the functions of the present invention and thus make it easier for developer to use the functions without undue specialized coding. The special subclasses discern and/or utilize the sector size and sector boundaries of the hard disk in question. Additional information, such as the buffer size and other parameters are used to eliminate the need for much of the buffering at the system memory. Unlike prior art systems (see FIG. 1), where I/O processing requires CPU utilization for movement in RAM and four simultaneous access to RAM, the present invention requires no CPU utilization for movement in RAM and has only two simultaneous access to RAM, thereby increasing throughput to the hard disk significantly.

The methods of the present invention can be embodied in hardware or software, or some combination of hardware and software. Ideally, the methods of the present invention are an encapsulation of file access method calls into a C++ class or a software type or structure. The encapsulated method calls are generally (although not required to be) similar to those used by developers so that the latter may take quick advantage performance of unbuffered I/O without worrying about the sector boundaries. For example, the call statements for the methods of the present invention can be written and similarity to those used by programmers familiar with, for example, the Microsoft Foundation Classes (“MFC”) for file access. MFC is available from the Microsoft Corporation of Redmond, Wash.

Unbuffered I/O access can achieve up to a 30% speed increase when accessing disk drives on, for example, 32 bit and 64 bit systems. Such an increase in I/O speed can shorten the time needed for many data load processes. The subclass of the present invention may be used for sequential writes and (perhaps) random writes within the file. The constraint to the programmer is that all writes, except the last write, must be a multiple of 1 kilobyte.

By not having as many contending accesses for memory usage and CPU context switching, throughput is maximized. In the case of the file-copy application of the present invention, there is almost 0 CPU utilization and half the memory contention of traditional methods.

The present invention provides four subclasses: open, read, write, and close. These four subclasses can be called by application programs that are developed for the platform in question. Although the techniques for information access are quite unlike the prior art, the application programming interface (“API”) calls can be made to look like standard API calls, thus minimizing the re-coding of existing software, or reeducation of the developer. Other methods, such as Seek, can also be included to further accentuate and enhance the capabilities of the present invention.

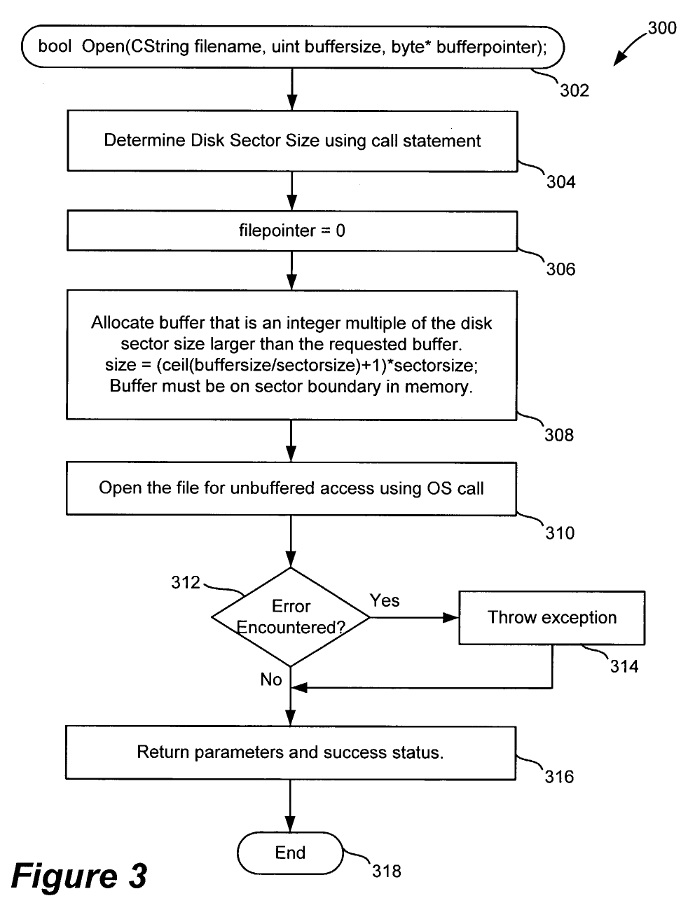

FIG. 3 illustrates the Open method of the present invention. The Open method determines the flags used for opening the file, as well as determines the sector size of the drive. The Open method may also allocate buffer memory and return one or more buffer pointers. Finally, the Open method may throw standard system exceptions in case of catastrophic failures. The Open method begins generally at step 302 where an Open (API) statement having one or more parameters is utilized by a developer in, for example, a software application. In the first main step of the Open method, the disk sector size is determined by using a call statement in step 304. The call statement can be an operating system call, or it can be a specialized routine for the specific hardware architecture. Thereafter, a file pointer parameter is set to a nominal value, such as “0” (which is the standard value for most programming languages) in step of 306. Thereafter, in step 308, a buffer is allocated as a function of a size parameter that may be designated by the requesting program. However, instead of simply allocating the buffer to the size designated by the requesting program, the size of the buffer allocated in step 308 is, for example, an integer multiple of the disk sector size larger than the requested size of the buffer. Typically, the size of the buffer that is allocated is determined by the formula:

size=(ceil(buffersize/sectorsize)+1)*sectorsize

where buffersize is the size of the buffer as requested by the calling program, and sectorsize is the disk sector size. Although not required, the buffer is allocated typically on a sector boundary in memory. The buffer allocation of the Open method of the present invention may also ensure that the buffer can be on a sector boundary within available memory. In short, the open method can return a buffer that is correctly aligned in memory or, for example, a sector boundary.

Referring again to the flowchart of FIG. 3, the next in the Open method is step 310, where a file is opened for unbuffered access using a call statement that is encapsulated in, for example, an application program, an operating system, a special library, or the like. The call statement can be, for example, a Win32 API call for the Windows operating system that is manufactured by the Microsoft Corporation of Redmond, Wash. Other operating systems, such as Linux (which is available on the Internet at http://www.kernel.org/) and Solaris, which is manufactured by Sun Microsystems of Palo Alto, Calif., are also involved via corresponding call statements. In some situations, the opening of the file in step 310 can result in an exception (error). Depending upon the programming language used to implement the method of the present invention, an object representing the error (exception) can be thrown. The thrown object can be subsequently caught by application-specific code so that the exception can be handled. In step 312, a determination is made if an error has been encountered. If so, then an exception object can be thrown in step 314 and handled, if necessary. After the exception is thrown and/or handled in step 314, or if no error was encountered, then execution proceeds to step 316, wherein any parameters expected by the calling routine are returned and the success indicator is provided. The method ends generally at step 318.

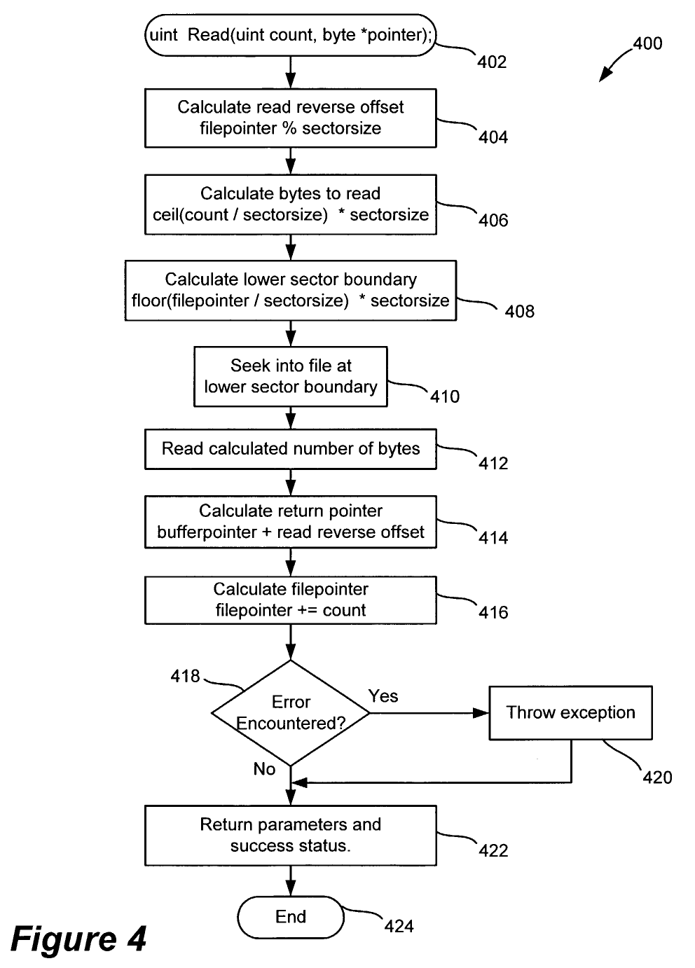

FIG. 4 illustrates a Read method 400 of the present invention. The read method 400 begins generally at step 402, wherein the read command is invoked by an application through, for example, an API, with one or more input parameters. In step 404, a read reverse offset is calculated with, for example, the file pointer that maintains the current read position in the file, as well as the sector size (“sectorsize”) of the given hardware on the computer system. Next, in step 406, the bytes to be read are calculated using, for example, the Ceil function using the count and sectorsize parameters. A typical byte calculation could be in the form of:

Ceil(count/sectorsize)*sectorsize

where count, for example, is one of the input parameters of the API call statement.

Referring again to FIG. 4, in step 408, the lower sector boundary, just before the current file position (that is stored in the file pointer variable), is calculated by the formula:

Floor(file pointer/sectorsize)*sectorsize

In steps 410 and 412, the calculated number of bytes is read from the position that was previously calculated as the lower sector boundary. Next, in step 414, the return pointer is calculated using, for example, the buffer pointer (“bufferpointer”) plus the read reverse offset, such that:

Return_Pointer=bufferpointer+read_reverse_offset

Thereafter, in step 416, the method's logical file pointer is altered, for example, by adding to it the byte count parameter (that is typically provided as one of the input parameters). Then, in step 418, a check is made to determine if an exception was encountered during the previous operations. If so, then step 420 is executed, wherein an exception related to the error is thrown and handled, if necessary. Otherwise, if the result of step 418 is negative, or after the exception has been thrown and/or handled, then execution proceeds to step 422 where return parameters and perhaps a success status indicator are provided to the calling program, and the Read method ends generally at step 424.

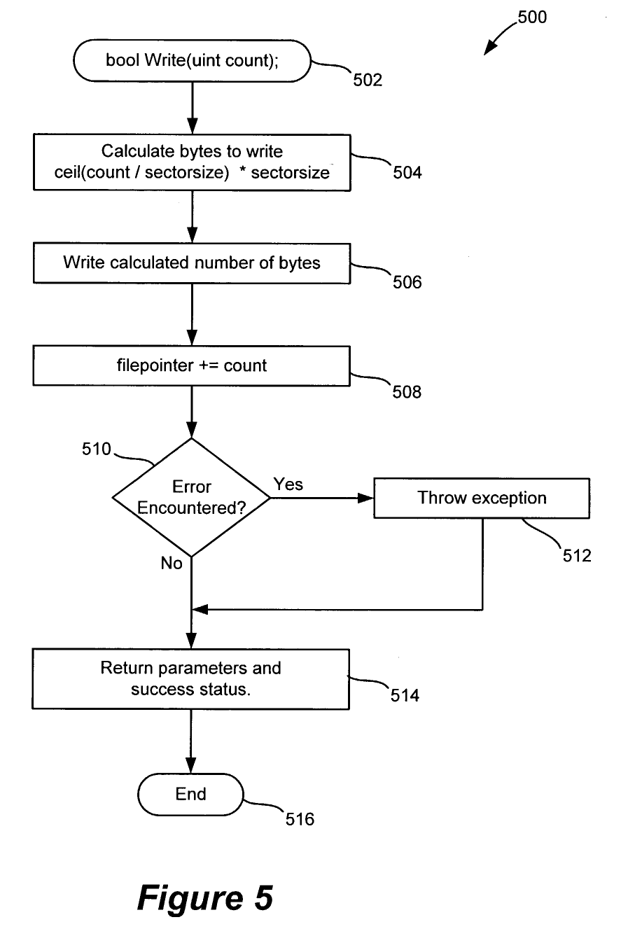

FIG. 5 illustrates the Write method 500 of the present invention. The Write method 500 begins generally at step 502 with a write statement being called as, for example, a library or operating system API call. In some embodiments, the Write statement 500 can have one or more input parameters as illustrated in FIG. 5. In step 504, the number of bytes to be written are calculated with, for example, the Ceil function using the count and sector size parameters, as illustrated in FIG. 5. A typical calculation can be in the form of:

Ceil(count/sectorsize)*sectorsize

where the count parameter was provided as one of the input parameters in the Write call statement. The Write statement can return the same value as the count parameter except for the last write where the user is not constrained to writes, that are, for example, multiples of 1K (1024) bytes. The sectorsize parameter is typically the sector size of the given (mass storage media) hardware on the computer system in question, although the sector size can be determined differently, if the hardware of the computer system warrants.

Referring again to FIG. 5, in step 506, the number of bytes that were calculated in step 504 are actually written to the mass storage device (e.g. drive 226 of FIG. 1). The storage device can be a hard disk, memory, or other device that is designed to store multiple bits of information. Then, in step 508, the file pointer is incremented using, for example, the count parameter. Then, in step 510, a check is made to determine if an error with the write operation was encountered. If so, an exception is thrown in step 512 and handled, if necessary. If no error was encountered, or after the exception has been thrown and/or handled, execution moves to step 514, wherein any return parameters and/or the success status indicator are provided to the calling routine, and the method ends generally in step 516.

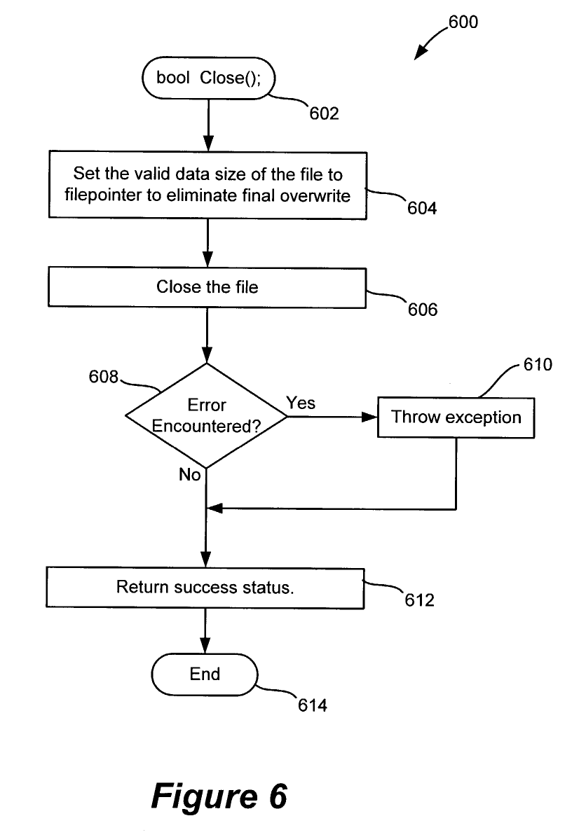

FIG. 6 illustrates the Close method 600 of the present invention. The Close method 600 is used to close files on the file system of the computer system 200 (see FIG. 2), and begins generally at step 602 with a call statement that may contain zero or more parameters. Next, in step 604, the valid data size of the file is set to the file pointer in order to eliminate final overwrite of the file in question. Next, in step 606, the file is closed. Thereafter, in step 608, a check is made to determine whether an error was encountered during the operation of step 608. If an error was encountered, then in step 610 an exception is thrown and handled, if necessary. If the result of step 608 is negative, or after the exception has thrown and/or handled, then execution moves to step 612 and the success status indicator is returned to the calling program, and the method ends generally at step 614.

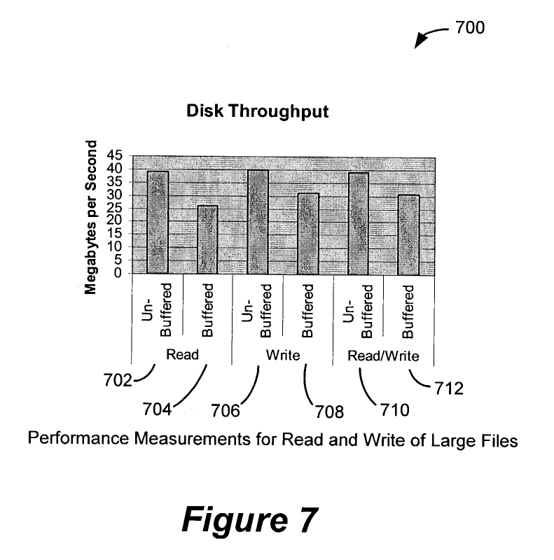

FIG. 7 is a plot of throughput (in megabytes per second) versus the type of disk throughput. The chart 700 is thus a performance measurement for read/write of large files and is an indication of the performance increase available with the methods of the present invention. For example, buffered reads throughput is roughly 26 megabytes per second. However, in the unbuffered state available through the methods of the present invention, the throughput rises significantly to close to 40 megabytes per second. Similar performance increases are illustrated on the unbuffered write 706 versus the buffered write 708 and the unbuffered read/write 710 in comparison to the read/write 712. The variations of the buffered and unbuffered performance are directly attributable to the methods of the present invention.

The invention, therefor, is well adapted to carry out the objects and to attain the ends and advantages mentioned, as well as others inherent therein. While the invention has been depicted, described and is defined by reference to exemplary embodiments of the invention, such references do not imply a limitation on the invention, and no such limitation is to be inferred. The invention is capable of considerable modification, alternation and equivalents in form and function, as may occur to those ordinarily skilled in the pertinent arts and having the benefit of this disclosure. The depicted and described embodiments of the invention are exemplary only, and are not exhaustive of the scope of the invention. Consequently, the invention is to be limited only by the spirit and scope of the appended claims, giving full cognizance to equivalents in all respects.

What is claimed is:

1. A computer system having a memory, and at least one mass storage device operative with said memory, comprising:
an open method, said open method constructed and arranged to open a file for unbuffered access, said file containing information;
a read method, said read method constructed and arranged to copy said information from said file;
a close method, said close method constructed and arranged to close said file;
whereby said information from said file is read from said file and moved to a second mass storage device.

2. A computer system having a memory, and at least one mass storage device operative with said memory, said memory containing information, comprising:
an open method, said open method constructed and arranged to open a file for unbuffered access;
a write method, said write method constructed and arranged to place said information into said file;
a close method, said close method constructed and arranged to close said file;
whereby said information from said memory is written to said file.

3. The system of claim 1, wherein said open method comprises:
determining a sector size of a storage medium;
allocating a buffer, said buffer being an integer multiple of said sector size of said mass storage device, said integer multiple being larger than a requested buffer size; and
opening said file for unbuffered access.

4. The method of claim 3, wherein said buffer is on a sector boundary in a memory.

5. The method of claim 3, wherein after said step of opening said file, then returning a parameter.

6. The method of claim 3, wherein after said step of opening said file, then checking for an error.

7. The method of claim 6, wherein if an error is encountered, then throwing an exception.

8. The method of claim 6, wherein if an error is encountered, then handling an exception related to said error.

9. The system of claim 1, wherein said read method comprises:
calculating a read reverse offset;
calculating the number of bytes to read;
calculating a lower sector boundary; and
reading said number of bytes from said file at said lower sector boundary.

10. The method of claim 9, wherein after said step of calculating said lower sector boundary, then seeking into said file at said lower sector boundary.

11. The method of claim 10, wherein said lower sector boundary is calculated with a floor function.

12. The method of claim 9, wherein after said reading said number of bytes from said file, then checking for an error.

13. The method of claim 12, wherein if an error is encountered, then throwing an exception.

14. The method of claim 12, wherein if an error is encountered, then handling an exception related to said error.

15. The method of claim 9, wherein after said step of reading said number of bytes from said file, then calculating a return pointer.

16. The method of claim 9, wherein after said step of reading said number of bytes from said file, then calculating a file pointer.

17. The method of claim 9, wherein after said step of reading said number of bytes from said file, then returning a parameter.

18. The method of claim 9, wherein after said step of reading said number of bytes from said file, then returning a status indicator.

19. The system of claim 2, wherein said write method comprises:
calculating the number of bytes to write to said storage medium; and
writing said number of bytes to said storage medium.

20. The method of claim 19, further comprising:
incrementing a file pointer.

21. The method of claim 19, further comprising checking for an error.

22. The method of claim 21, wherein if an error is encountered, then throwing an exception.

23. The method of claim 19, further comprising returning a parameter.

24. The method of claim 19, further comprising returning a status indicator.

25. The system of claim 1, wherein said close method comprises:
setting the data size in said file to a file pointer; and
closing said file.

26. The method of claim 25, further comprising checking for an error.

27. The method of claim 26, wherein if an error is encountered, then throwing an exception.

28. The method of claim 25, further comprising returning a status indicator.
